(19) United States
(12) Patent Application Publication
(10) Pub. No.: US 2016/0196676 A1
(43) Pub. Date: Jul. 7, 2016

(54) Using Character Classes for Font Selection

(71) Applicant: Monotype Imaging Inc., Woburn, MA (US)

(72) Inventors: Christopher John Chapman, Lexington, MA (US); Mohit Gupta, Delhi (IN); Vishal Natani, Jaipur (IN)

(21) Appl. No.: 14/613,751

(22) Filed: Feb. 4, 2015

Related U.S. Application Data
(60) Provisional application No. 62/099,283, filed on Jan. 2, 2015.

(51) Int. Cl. G06T 11/60

(52) U.S. Cl. CPC G06T 11/60

(57) ABSTRACT

A system includes a computing device that includes a memory configured to store instructions. The system also includes a processor to execute the instructions to perform operations that include receiving data representing a text character for being rendered on a display in a supporting font. Operations also include identifying the received text character as a member of one of two character classes. If the text character is identified as a class one character, operations include maintaining use of a current font, even if different from the supporting font, to render the class one character on the display. If the text character is identified as a class two character, operations include switching from the current font to another font only if the class two character is unsupported by the current font. Operations also include rendering the received text character on the display.

### CLAIM OF PRIORITY

This application claims priority under 35 USC §119(e) to U.S. Patent Application Ser. No. 62/099,283, filed on Jan. 2, 2015 the entire contents of which are hereby incorporated by reference.

### BACKGROUND

This description relates to defining and using character classes for selecting fonts to present the characters. Along with selecting appropriate fonts for visual attributes such as to present legible text, improvements in computational efficiency can be realized through font selection.

Proportional to the astronomical growth of available text content, for example via the Internet, the demand to express such content has grown. The use of different languages, presentation styles, aesthetics, etc. has driven the development of thousands of fonts to express such textual content. Based upon this sheer growth and number of different languages represented, some fonts may appear to visually complement other fonts while other combinations of fonts may not be quite as compatible and may even be visually distracting when presented together. Further, computational performance of the presenting device may suffer when switching between multiple fonts to present the text.

### SUMMARY

The systems and techniques described can aid in harmoniously presenting multiple fonts (e.g., of different languages, styles, etc.) to provide legible content while also improving the computational performance for presenting the text. By focusing on the similarity or differences of adjacently positioned characters (e.g., neighboring characters in a string of text), executed operations can determine whether to switch to a different fonts, continue using the current font, etc. By reducing the number of instants of switching between two or more fonts, the computational efficiency for preparing text content for rendering can be improved.

In one aspect, a computing device implemented method includes receiving data representing a text character for being rendered on a display in a supporting font. The method also includes identifying the received text character as a member of one of two character classes. If the text character is identified as a class one character, the method includes maintaining use of a current font, even if different from the supporting font, to render the class one character on the display. If the text character is identified as a class two character, the method includes switching from the current font to another font only if the class two character is unsupported by the current font. The method also includes rendering the received text character on the display.

Implementations may include one or more of the following features. The class one characters may include non-viewable characters. The class two characters may include characters displayable in multiple fonts. The class two characters may include a viewable character that combines with another character to form a single character. The method may include decomposing the received text character into component characters. The method may include identifying a base component character for identifying a font for rendering other component characters. The base component character may be identified from use of visual baseline space. Identifying the font for rendering the other component characters may be based upon the number of component characters representable by the font. Identifying the received text character as a member of one of two character classes may include identifying a previously received text character that represents a common character or a line break. Identifying the received text character as a member of one of two character classes may be executed by a user computing device. Identifying the received text character as a member of one of two character classes may be executed at a font service provider.

In another aspect, a system includes a computing device that includes a memory configured to store instructions. The system also includes a processor to execute the instructions to perform operations that include receiving data representing a text character for being rendered on a display in a supporting font. Operations also include identifying the received text character as a member of one of two character classes. If the text character is identified as a class one character, operations include maintaining use of a current font, even if different from the supporting font, to render the class one character on the display. If the text character is identified as a class two character, operations include switching from the current font to another font only if the class two character is unsupported by the current font. Operations also include rendering the received text character on the display.

Implementations may include one or more of the following features. The class one characters may include non-viewable characters. The class two characters may include characters displayable in multiple fonts. The class two characters may include a viewable character that combines with another character to form a single character. Operations may include decomposing the received text character into component characters. Operations may include identifying a base component character for identifying a font for rendering other component characters. The base component character may be identified from use of visual baseline space. Identifying the font for rendering the other component characters may be based upon the number of component characters representable by the font. Identifying the received text character as a member of one of two character classes may include identifying a previously received text character that represents a common character or a line break. Identifying the received text character as a member of one of two character classes may be executed by a user computing device. Identifying the received text character as a member of one of two character classes may be executed at a font service provider.

In another aspect, one or more computer readable media storing instructions that are executable by a processing device, and upon such execution cause the processing device to perform operations that include receiving data representing a text character for being rendered on a display in a supporting font. Operations also include identifying the received text character as a member of one of two character classes. If the text character is identified as a class one character, operations include maintaining use of a current font, even if different from the supporting font, to render the class one character on the display. If the text character is identified as a class two character, operations include switching from the current font to another font only if the class two character is unsupported by the current font. Operations also include rendering the received text character on the display.

Implementations may include one or more of the following features. The class one characters may include non-viewable characters. The class two characters may include characters displayable in multiple fonts. The class two characters may include a viewable character that combines with another character to form a single character. Operations may include decomposing the received text character into component characters. Operations may include identifying a base component character for identifying a font for rendering other component characters. The base component character may be identified from use of visual baseline space. Identifying the font for rendering the other component characters may be based upon the number of component characters representable by the font. Identifying the received text character as a member of one of two character classes may include identifying a previously received text character that represents a common character or a line break. Identifying the received text character as a member of one of two character classes may be executed by a user computing device. Identifying the received text character as a member of one of two character classes may be executed at a font service provider.

These and other aspects, features, and various combinations may be expressed as methods, apparatus, systems, means for performing functions, program products, etc.

Other features and advantages will be apparent from the description and the claims.

### DESCRIPTION OF DRAWINGS

FIG. 1 illustrates a smartphone presenting textual content.

FIG. 2 is a block diagram of components of the smartphone presented in FIG. 1.

FIG. 3 is a block diagram of an Internet based computer network that distributes font associated information to user devices.

FIGS. 4 and 5 illustrate situations in which font switching is adjusted.

FIGS. 6-11 are flowcharts for controlling the switching of fonts.

FIG. 12 illustrates an example of a computing device and a mobile computing device that can be used to implement the techniques described here.

### DETAILED DESCRIPTION

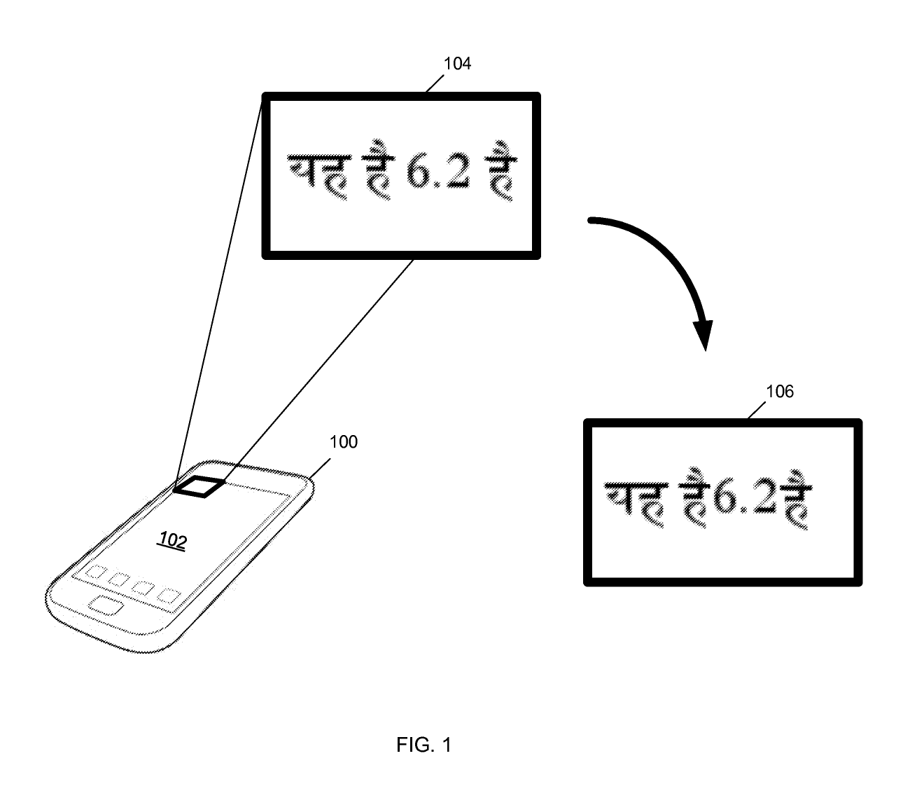

Referring to FIG. 1, a computing device (e.g., a smartphone 100) includes a display 102 that allows a user to view, edit, etc. various types of content, such as text, through the execution of one or more applications (e.g., a browser, a word processor, etc.). To render such text, fonts stored in the device are typically utilized. However instances may occur when all of the text cannot be rendered, e.g., due to the fixed number of addressable glyphs in a single font instance. Typically a font is limited to 64K glyphs (e.g., 65,535 glyphs, etc.) based upon the number of bits (i.e., 16 bits) available for addressing each individual glyph. This problem can be amplified when attempting to render documents (or other types of electronic assets) that contain multilingual text. Typically a single font does not include enough glyphs to support the characters of multiple languages. In some arrangements, multiple fonts are combined to provide the support, e.g., composite font representation (CFR), Linked Fonts (produced by Monotype Imaging Inc. of Woburn, Mass.), etc. For applications in which text that is static (e.g., electronic newspapers), the particular characters used may be bound to particular fonts. However, for applications in which text can dynamically change, such as in text editing applications, static binding of fonts and characters may call for a single collection of fonts that covers all characters (e.g., all Unicodes).

Rather than having an extremely large collection of fonts to handle each and every possible character, which may be impractical for local memory, a relatively smaller group of fonts may be employed. For example if a character is identified for display (e.g., input into a text editor), a font selected by the user (or a default font) can be checked to determine if the character is supported. If unsupported, the group of fonts can be interrogated (e.g., in an iterative manner) to determine if one of the fonts contains the character that is missing from the user selected (or default font).

By identifying a particular font for each character, switching between different fonts is probable, e.g., to support the different characters in a text string or multiple strings received for presentation. In numerous instances such switching among fonts may be unnecessary and may even cause displayed text to appear distorted and less readable. Further, unnecessarily switching among fonts may hinder device operations and thereby reduce computational performance. As illustrated in the figure, the display 102 presents a string of characters 104 that include both Devanagari characters and a numerical quantity presented in a Latin font. In this example, the Latin font has been selected as the default font (e.g., by the user) and since the Devanagari characters are not supported by the Latin font, the computing device uses a Devanagari font to present these characters. Since the numerical digits and decimal point are recognized as being supported by the Latin font, the device switches to the Latin font to present the numerical quantity before switching back to the Devanagari font to present the final Devanagari character. However, the Devanagari font also supports numerical digits and the decimal point. As such, the device has unnecessarily switched from the Devanagari font, to the Latin font, and back to the Devanagari font, thereby degrading computation performance of the device. Further in some instances, the graphical output of the device may be compromised based upon the unnecessary switching between fonts. For example, by not switching fonts and exclusively using the Devanagari font, characters 106 may be presented in a more consistent manner (e.g., appropriate spacing between characters, vertical alignment of adjacent characters, etc.).

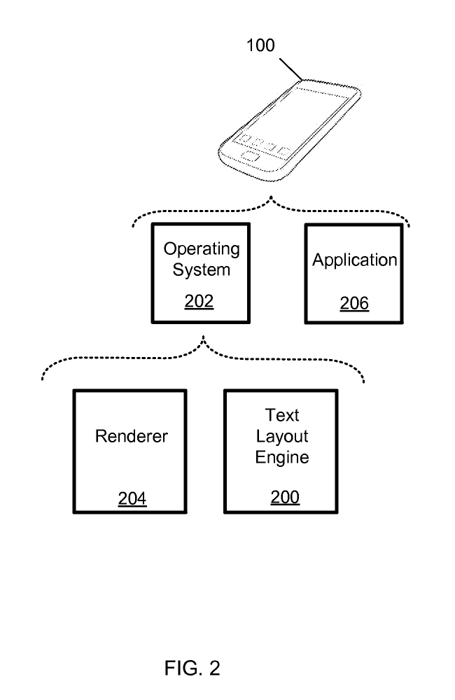

Referring to FIG. 2, various architectures, processes, etc. may be utilized to determining when to switch among different fonts to present text content. In this particular example, a text layout engine 200 included in an operating system 202 of the smartphone 100 executes operations to identify an appropriate font for presenting each character (e.g., of a document or other type of electronic asset such as a webpage, website, etc.). Once determined, the appropriate font data for the character of interest is provided to a renderer 204 that is executed by the smartphone 100. To illustrate, an application 206 (e.g., web browser, text editor, etc.) executed by the smartphone 100 provides textual content to the text layout engine 200 that in turn determines the one or more needed fonts to present the content. Once determined, font data (e.g., data representing character outlines, etc.) is provided to the renderer 204 for presenting the characters in the appropriate font on the smartphone 100. The text layout engine 200 may be implemented in software, hardware, combinations of software and hardware, etc. Microprocessor architectures can also be employed to provide the functionality of the text layout engine 200 along with other portions of the computing device (e.g., the renderer 204, operating system, etc.). As such, operations can be locally executed to determine whether to efficiently continue to use a current font or switch to another font. However, operations may be executed external to the device (e.g., the smartphone 100) to potentially improve the performance regarding font selection and displaying text.

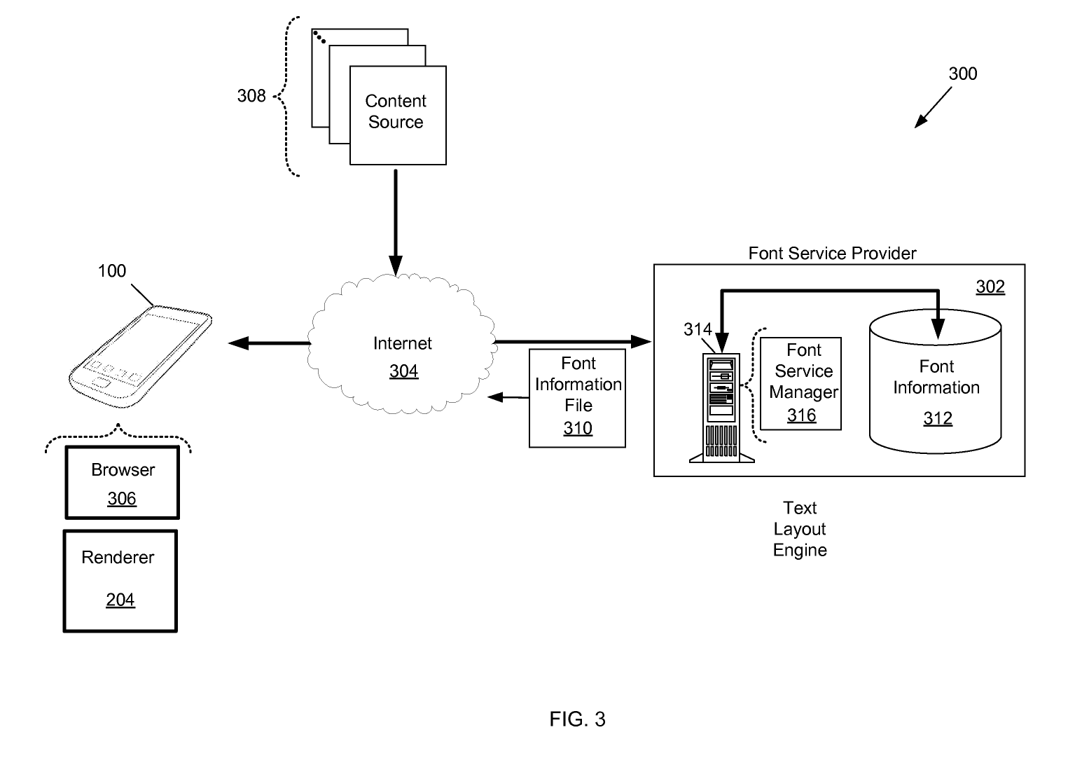

Referring to FIG. 3, a computing environment 300 is presented that is capable of providing font information for presenting textual content for a variety of sources. For example, font information can be provided to user devices as needed for presenting content such as multilingual text. Assets (e.g., electronic documents, webpages, websites, etc.) can be provided from the sources to the user devices, and a font service provider 302 can provide the font information to the user devices through various types of networks and connections (e.g., the Internet 304). In this illustrated example, the smartphone 100, which is capable of interacting with a user (via a touch display, keypad device, etc.), is connected to the font service provider 302 via the Internet 304 (though other types of networking architectures may be employed). The smartphone 100 can execute one or more applications (e.g., a browser 306) to request and present content (e.g., text, graphics, video, etc.) of assets (e.g., a web page, a website, etc.) provided from a variety of content sources 308 (e.g., remote servers or other types of computing devices etc.).

One or more techniques may be utilized by the font service provider 302 to provide the user device (e.g., the smartphone 100) with the needed font information (e.g., multilingual character fonts). In some arrangements one or more requests may be sent from the user device for the needed information; for example, a software agent (e.g., provided by the font service provider 302) may be executed by the user device to identify needed information and initiate sending a request. Such an agent (e.g., executable instructions) generally operates in an autonomous manner (and in some instance also continuously). Generally an agent is not inhibited by other processes (e.g., other agents) and may also have the capability of learning through its functioning over a period of time. For example, the agent may repetitively monitor the text to be rendered (e.g., by the renderer 204) on the user device and correspondingly request font information as needed. Such functionality may also be provided, or partially provided by the font service provider 302. For example, as content is requested by the user device (e.g., the browser 306 requests a webpage from one of the content sources 308) the font service provider 302 may determine which font information is needed by the user device (e.g., by tracking the fonts present at the smartphone 100, the capabilities of the smartphone, etc.) and provide the information. In another arrangement, the font service provider 302 may work with the content sources such that appropriate font information is provided (e.g., from the source) to user devices along with the content of the asset of interest.

One or more data transfer techniques may be implemented to provide the font information to the user devices (e.g., the smartphone 100). For example, one or more files (e.g., a font information file 310), data streams, and other type of data transport mechanisms may be employed. In some arrangements, the font service provider 302 may also provide executable instructions (e.g., programs, functions, etc.) in order to perform operations, such as one or more software agents for executing on the user devices. Along with instructions to assist with providing font information for presenting text, other types of functionality may or may not be provided. For example, instructions may be included in files(s) (e.g., the font information file 210) that when executed may identify the font stored by the user device, etc.

To provide the appropriate font information to the smartphone 100, the font service provider 302 may access one or more libraries of fonts, font information, etc. that may be stored locally or remotely. For example, font libraries and libraries of font information may be stored in a storage device 312 (e.g., one or more hard drives, CD-ROMs, etc.) on site (at the font service provider 302). Being accessible by a server 314, the libraries may be used, along with information provided by the smartphone 100 (e.g., included in a request message), to attain the appropriate font information. Illustrated as being stored in a single storage device 312, the font service provider 302 may also use numerous storage techniques and devices to retain collections of fonts and related font information (e.g., fonts for multiple languages, styles, etc.). The font service provider 302 may also access font information at separate locations as needed. For example, along with identifying language fonts potentially needed for the smartphone 100 and other user devices, the server 314 may also be used to collect fonts associated with other languages, etc. from one or more sources external to the font service provider 302 (e.g., via the Internet 304).

To provide the functionality of managing the distribution of font information (such as multilingual fonts) to potential recipient devices such as the smartphone 100, the server 314 executes a font service manager 316, which, in general can provide all or a portion of the functionality of the test layout engine 200 (shown in FIG. 2). Along with this functionality, the font service manager 316 may also manage fonts, data associated with fonts, storage of font information for later retrieval, etc. As such, font information may be quickly identified and provided to a requesting computing device (e.g., the smartphone 100). In one arrangement, a database (or other technique for structuring and storing data) is stored at the font service provider 302 (e.g., on the storage device 312) and includes records that represent the fonts and related information. In some instances, the font information is identified in part from information provided by a request (or multiple requests) sent to the font service provider 302. Similarly, the font service provider 302 may perform operations (e.g., tracking, monitoring, etc.) regarding types of information to be sent, preserved, used, etc. For example, records may be stored for future use that reflect particular fonts that have been requested from, provided to, etc. a computing device, the type of computing device, etc.

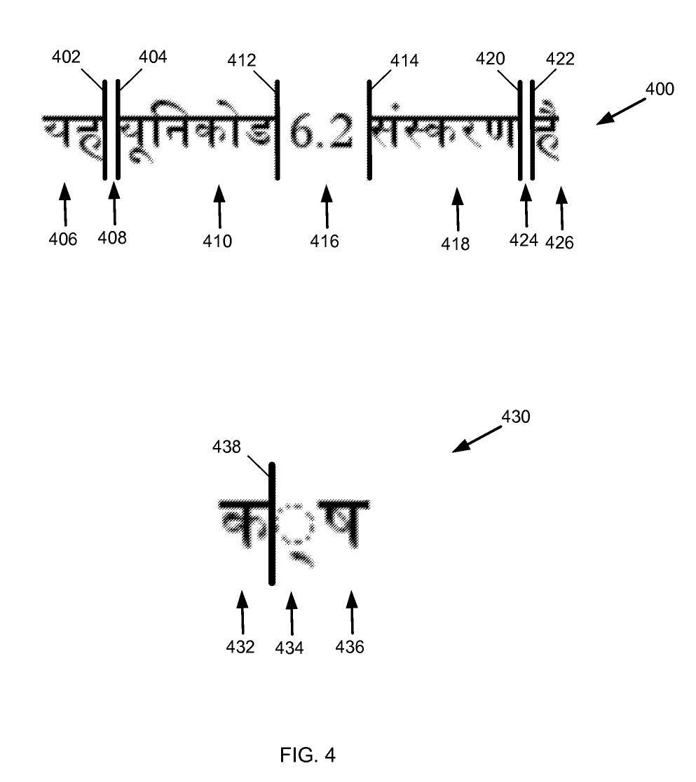

Referring to FIG. 4, operations of the font layout engine 200 (shown in FIG. 2), or other implementation types (e.g., functionality provided by the font service manager 316), can include determining whether switching between fonts would be appropriate or not. In some instances, switching fonts to handle missing characters can hinder computational performance, output incorrect typographic representations, etc. To demonstrate the potential inefficiency of switching between fonts, a Latin font is applied to a string of text 400 that includes a number of Devanagari characters. Such Devanagari characters are not represented in the characters of the Latin font. As such, the computing device (e.g., the smartphone 100) would typically rely on a different font for appropriately representing these characters (e.g., a font that supports Devanagari). However, more commonly known characters such as spaces, digits, punctuations, etc. could be supported by the user-selected Latin font. As such, switching between fonts would occur between some of the Devanagari characters and the common characters representable in the Latin font. In the figure, the transitions are represented by vertical line. For example, lines 402 and 404 represent the switch from the Devanagari font (for characters 406) to the Latin font (for character 408 that represents a space) and then a switch back to the Devanagari font (for characters 410). Lines 412 and 414 respectively represent the switches from the Devanagari font (for characters 410) to the Latin font (for the characters 416 that represent a numerical value) and then back to the Devanagari font (for characters 418). Lastly, lines 420 and 422 represent the switching again from the Devanagari font (for characters 418) to the Latin font (for characters 424 that represents another space) and back to the Devanagari font (for character 426). As such, font switching occurred in six instances within this relatively short string of text 400. As can be imagined, computational performance can be impacted due to such font switching for strings of similar length and longer.

Similar inefficient font switching may occur when using characters that are typically employed for shaping text in comparison to actually presenting text. For example, control characters can be considered non-printing characters that control the connections between individual characters. Such control characters may be font dependent or independent of font type. One such character, referred to as a zero-width joiner (ZWJ) can be placed between two characters to cause the pair to be printed in a connected form. Another non-printing character, referred to as a zero-width non-joiner (ZWNJ), can cause two characters to be printed slightly separate (through closer than the separation provided by a space character). Similar to switching from one font to another to address spaces, fonts may be switched for control characters and can cause incorrect shaping, broken text, etc. As presented in the figure, a string of text 430 includes three printed Devanagari characters 432, 434, 436 and one vertical line 438 that represents the font switching location. In this particular example fonts are switched twice at the location of vertical line 438. The Unicode sequence for this four-character text string 430 is “U+915 U+200C U+094D U+0937”. From left to right, “U+915” represents character 432, “U+200C” represents the ZWNJ character (which is not viewable), “U+094D” represents character 434 and “U+0937” represents character 436. At line 438, the font is switched from the Devanagari font (used for character 432) to a Latin font for the ZWNJ character (“U+200C”), and then back to the Devanagari font for the character 434. Based upon the font switching (multiple switches in this instance), inappropriate grapheme breaking may be detectable in the displayed string of text. By reducing, or even eliminating, the switching between the fonts and using the zero-width non-joiner control character from the Devanagari font, a more visually and aesthetically pleasing text string may be presented without excessively taxing the computing device such as the smartphone 100.

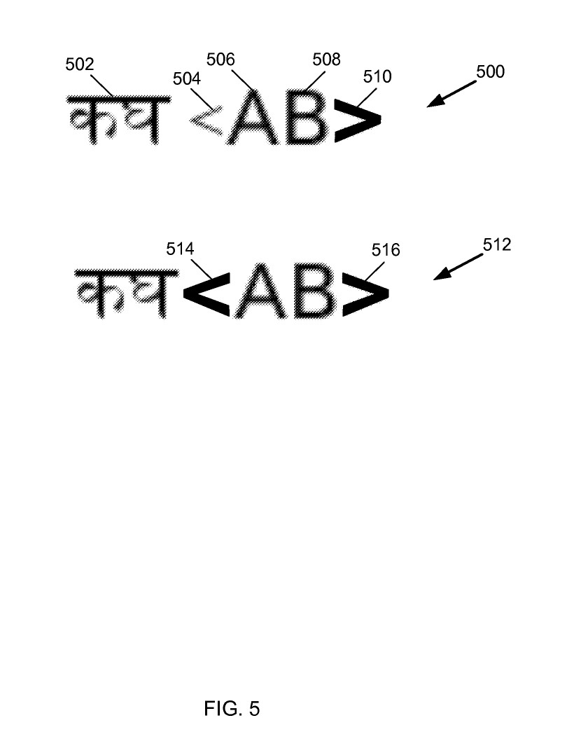

Referring to FIG. 5, similar to visual distractions caused by switching fonts for characters common to both fonts (e.g., a character representing a space), the relationship between characters may also cause inappropriate text being presented. A string of text 500 is illustrated in which Devanagari characters 502 first appear, when reading from left to right, followed by an opening bracket character 504. Since the applied Devanagari font supports such punctuation marks, the opening bracket character 504 is presented in the Devanagari font. But since the Devanagari font is absent Latin characters, a switch to a Latin font occurs for presenting the Latin characters 506, 508. Since the closing bracket 510 is also supported by the Latin font, the bracket character 510 is presented in the Latin font (and no switch is made back to the Devanagari font). As such, the opening and closing brackets 504 and 510 utilize different fonts and do not visually or aesthetically agree with each other.

By attempting to reduce the instances of switching between fonts for characters commonly supported the two fonts, performance of the text layout engine 200 (shown in FIG. 2), the font service provider 302 (shown in FIG. 3), etc. may be improved along with presenting more visually pleasing text to an end user. As illustrated with an improved text string 512, by alerting the text layout engine to the relationship between the opening and closing brackets, an appropriate font (in this case the Latin font) may be selected for presenting an opening bracket 514 and closing bracket 516 whose graphical features more closely match.

One or more techniques may be utilized to reduce the amount of font switching and thereby present more visually correct text while lessening the hindrance on computation performance. For example, characters may be characterized and assigned to one or multiple predefined classes. Once assigned, rules may be identified (based on the class assignment) and operations executed to determine which font to use (e.g., determine whether or not to switch fonts to prepare text for rendering).

In one arrangement, three classes may be defined for assigning characters. For a first class, particular characters that are common to multiple scripts can be assigned membership. In general, a script can be considered a writing system that can include one or more character sets, rules for composition and layout, etc. A script can support one or multiple languages, for example the Latin script can support English, German, French, etc. These particular common characters are also control characters that effect the formatting but are absent viewable glyphs (e.g., non-printable characters). Characters such as spaces, paragraph separators, soft hyphens, tabs, etc. can be assigned to class one. As with almost all characters of the known writing systems, each character can be represented by Unicode, a computing industry adopted standard for expressing text. For example paragraph separators are represented in Unicode as U+000a and U+000d. Similarly soft hyphens can be represented as U+00AD and tabs as U+0009. Such Unicodes and other types of character representations can be used for such class assignments. Since class one includes non-viewable control characters (e.g., not noticeable by an end viewer) that are common to multiple fonts, computational efficiency can be improved by not switching from one font to another when a class one character is detected.

A class two character can be defined to include characters common to multiple scripts that are not included in the class one. For example, characters that are viewable (e.g., include a printable glyph) and that are common to more than one script can be assigned to class two. As such, characters such as numerical digits, punctuation marks, etc. which are common to multiple scripts, can be assigned to this class two. Similar to common use by multiple scripts, other script properties may be used for assigning characters to class two. Some characters can be considered as having inherited script properties such as characters that inherit their script from a preceding character, a base character, etc. Diacritic characters, which can be considered as non-spacing marks that do not consume space along the visual baseline, can be assigned membership as class two characters. Other characters that do not consume visual baseline space can be identified as second class characters. Such characters include zero-width joiner characters (ZWJ), which cause a pair of characters to be printed in a connected form, and zero width non joiner characters (ZWNJ), which cause characters to be displayed in a separated form, can also be considered as a class two character.

Along with identifying characters as being members of class one or class two, another character class may be used for the remaining characters not assigned to either of these classes. Such remaining characters are assigned to class three. With the characters assigned to one of these three classes, operations regarding the class assignments can be executed by the text layout engine 200, the font service manager 316, etc. for determining whether to switch between fonts in preparation of rendering the characters, and thereby improve computational efficiency.

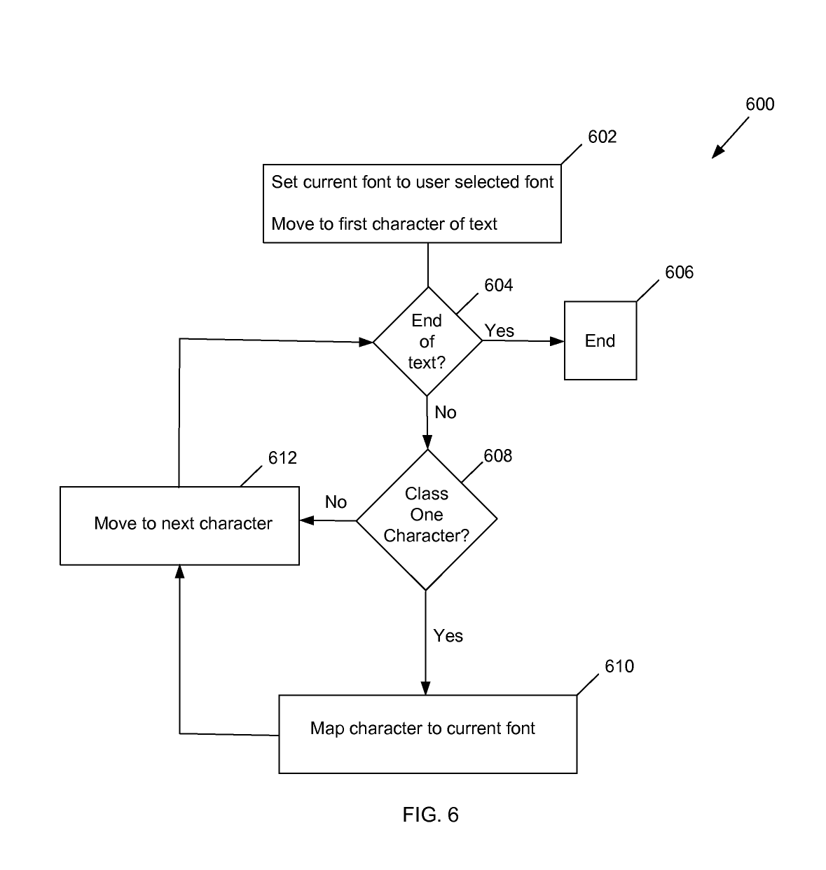

Referring to FIG. 6, a flowchart is presented that graphically illustrates operations to parse the text of an electronic asset (e.g., webpage, website, electronic document, etc.) and execute operations associated with a class one character being detected. In general, if a class one character is detected, a font switch is no executed. In this arrangement, a user selected font is set 602 as a default font. Additionally at this step, parsing of the provided text is initiated (e.g., by identifying the first character of the text). A loop is established to step through each character present in the text (e.g., by determining 604 if the end of the text passage has been reached). If reached, operations conclude 606, but if all characters have not been processed operations are executed to determine 608 if the current character is a class one character. If identified as a class one character, the current font (e.g., the user selected font) is retained and the detected class one character is mapped 610 to the current font. If determined that the character being investigated is not a class one character, operations are executed to move 612 to the next character of test. Based upon these operations, the current font (e.g., the user selected font) is not switched and is used for rendering class one characters such as control characters that includes no visible glyph and is supported by the current font.

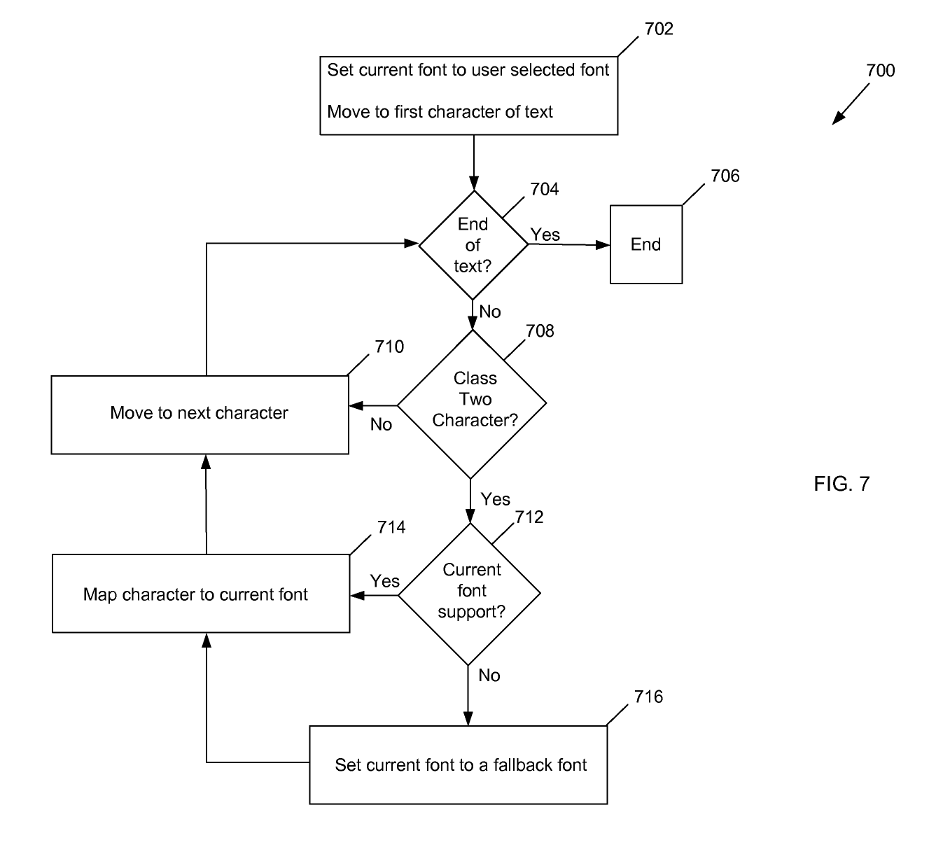

Referring to FIG. 7, a flowchart 700 is presented that illustrates operations for parsing an asset (similar to the operations of FIG. 6) and determine if class two characters are present. Also similar to the flowchart of FIG. 6, a user selected font is set 702 as a default font and parsing of the provided text is initiated (e.g., by identifying the first character of the text). A loop is established for investigating each character present in the text (e.g., by determining 704 if the end of the text passage has been reached). If reached, operations conclude 706, but if all characters have not been processed operations are executed to determine 708 if the current character is a class two character. If not identified as a class two character, looping continues by moving 710 to the next character (e.g., step from left to right in the text to the next character). If identified as a class two character, executed operations determine 712 if the class two character is supported by the current font. If supported, the character is mapped 714 to the current font (i.e., the user selected font) for rendering. If the current font does not support the identified class two character, current font is set 716 to a fallback font and the character is then mapped 714 to this fallback font before looping to the next character present in the text. Since class two characters are common to multiple scripts, these characters are generally supported by a number of fonts. As such, initially the current font is checked for supporting the character, which in effect can determine if the font used for the previous character also supports the class two character. For instances in which the class two character is not supported by the current font, a fallback font is checked for supporting the character and a font switch occurs if the character is supported. In some arrangements, multiple fallback fonts may be searched to determine if the character is supported. However, the number of fallback fonts checked may be restricted for computational efficiency.

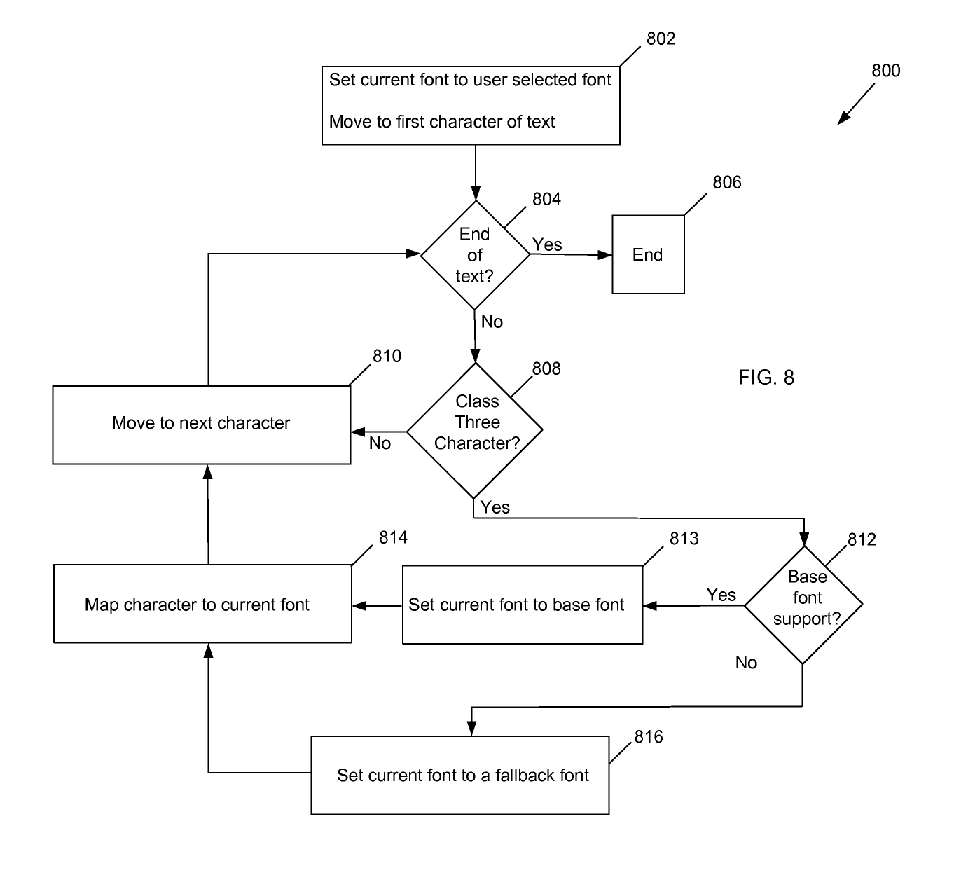

Referring to FIG. 8, a flowchart 800 is presented that illustrates operations for parsing an asset (similar to the operations of FIGS. 6 and 7) and determining if class three characters are present and then taking appropriate actions. Also similar to the flowcharts of FIGS. 6 and 7, a user selected font is set 802 as a default font and parsing of the provided text is initiated (e.g., by identifying the first character of the text). A loop is established for investigating each character present in the text (e.g., by determining 804 if the end of the text passage has been reached). If the end of the text is reached, operations conclude 806, but if all characters have not been processed operations are executed to determine 808 if the current character is a class three character. Since class three characters can be considered as remaining characters that are not class one or class two characters, operations of the flowchart 800 can be executed in concert with operations illustrated in flowcharts 600 and 700, in some arrangements. If not identified as a class three character, looping continues by moving 810 to the next character. If identified as a class three character, executed operations determine 812 if the class three character is supported by the base font (e.g., the user selected font). If supported, the base font is set 813 to the base font, and, the character is mapped 814 to the current font for rendering. If the current font does not support the identified class three character, a fallback font (or multiple fallback fonts) can be searched to determine if the character is supported by the fallback font. Once a supporting fallback font is found, the current font is set 816 to the fallback font and the character is then mapped 814 to this fallback font before looping to the next character present in the text. Through the operations illustrated in flowcharts 600, 700 and 800, the instances of unnecessary switching between fonts is reduced, thereby improving computational performance and efficiency.

While each character of an asset may be assigned to one of the predefined character classes (e.g., class one, two or three), instances can occur in which particular characters (of the asset) are unsupported by a font (e.g., a user selected font, a fall back font, etc.). In one instance, a character may be composed of multiple characters (e.g., a ligature in which characters form a single character). Similarly a character may be composed of two or more graphemes (e.g., a base character and multiple diacritics) and these types of composite characters may not be supported by a font. In such instances, operations may be executed (e.g., by the text layout engine 200, the font service manager 316, etc.) to determine if an appropriate font (or fonts) can be identified that support the individual components of the composite character. One or more techniques may be utilized to decompose such characters into components. For example, policies promulgated by the Unicode Consortium of Mountain View, Calif. may be employed such as rules provided by the Unicode technical report, “Unicode Normalization Forms”, Unicode Standard Annex (UAX) #15, which is incorporated by reference in its entirety herein. Also, rules that govern grapheme boundaries may be employed such as those also promulgated by the Unicode Consortium and provided by “Unicode Text Segmentation”, Unicode Standard Annex (UAX) #29, which is also incorporated by reference in its entirety herein. Using these rules a primary character (for a ligature or other type of composite character) may be identified (and referred to as a base character) along with one or more secondary characters (e.g., a second character included in a ligature, one or a series of secondary components such as diacritics, etc.). In one arrangement, once decomposed into components, the text layout engine 200, font service manager 316, etc. can attempt to identify a font for rendering the composite character. For example, one or more predefined rules can be employed to identify the font. For example, if one font is capable of supporting all of the decomposed character components, the font would be selected for rendering. Similarly, if a majority of the character components are supported by a particular font, that font can be selected for rendering. In one instance, a font that supports the primary character or component (e.g., the first character included in a ligature) may be identified for rendering the ligature. In another example, operations may be executed to determine if one particular font supports a maximum number of the decomposed character components. For example, if a character is decomposed into five components and a font is identified as supporting four (of the five) components, that font can be selected to prepare the composite character for rendering. Other types of conditions, criteria, etc. may be used for font selection; for example, preferences may be assigned to the decomposed character components. For demonstrative purposes, an e circumflex acute character can be illustrated as: [symbol] and can be considered as including a base character (the letter “e”): [symbol] that forms the base of the entire character, a circumflex character, [symbol] , and an acute character: [symbol] . Similar to this type of grapheme cluster, such techniques can be employed with other cluster types (e.g., surrogate pairs, consonant clusters, etc.). In this example, highest preference is assigned to the base character, which is the first decomposed component, followed by the next preference being assigned to the circumflex and lowest preference being assigned to the acute character. As such, a font that supports the base character would be selected over a different font that could just support the circumflex character or the acute character. Similarly, based upon the preference assigned to the base character, a font that supports just the base character would be selected over a font that supports both the circumflex character and the acute character. For another example in which preferences are used, a composite character is decomposed into four component characters A, B, C, D, with A being assigned the highest preference, then B followed by C, and D being assigned the lowest preference. A font that supports the two higher preference component characters (A and B) would be selected over a different font that supports combinations of component characters having an overall lesser preference (e.g., component character A in combination with C and D). Other types of criteria, conditions, rules, etc. may be employed for selecting a font to prepare a composite character for rendering. In some arrangements, multiple fonts can be selected for preparing such a character; for example, a font may be selected for components of the composite character or font selections may be confined to a particular number of fonts. For example, based upon preferences assigned to the individual character components, two, three or another predefined number of fonts may be selected for character rendering preparation.

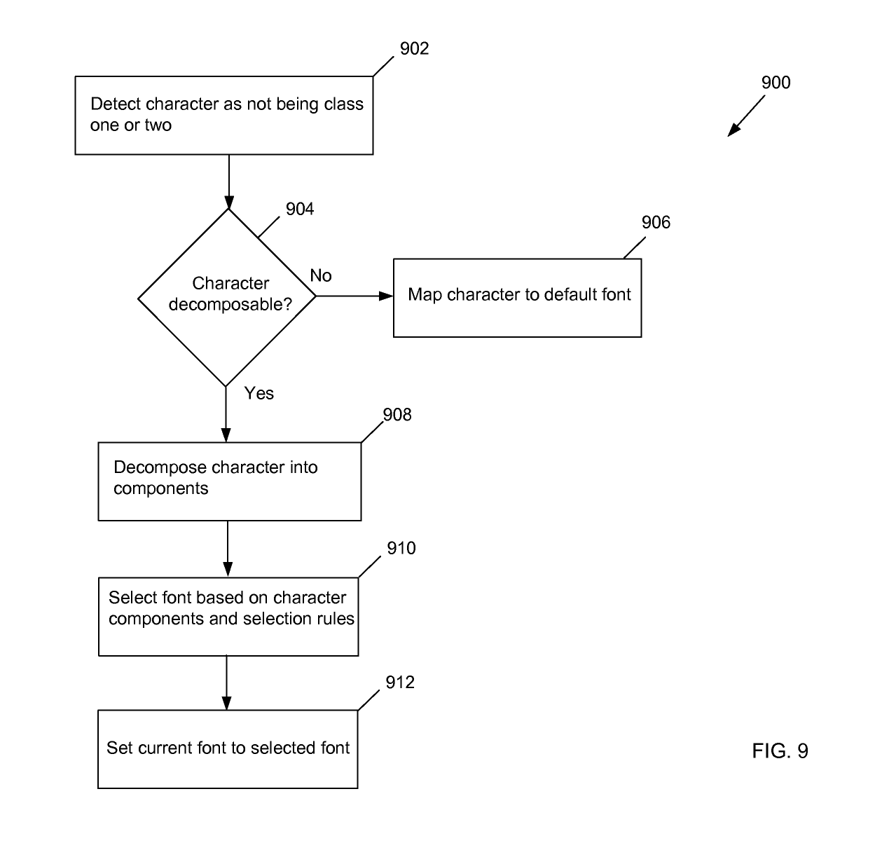

Referring to FIG. 9, a flowchart 900 is presented that illustrates operations for selecting one or more fonts to present a composite character that is rendered in a single space and includes a combination of component characters. Upon detecting 902 that a character has not been identified as a class one or class two character, operations are executed to determine 904 if the character can be decomposed into component characters. For one technique, the Unicode of the character can be examined to determine if the character has been produced from Unicode character data. If determined that the character cannot be decomposed into component characters, the character may be mapped 906 to a default font which may be a user selected font, a fallback font, etc. If the character is decomposable, operations are executed to decompose 908 the character into two or more component characters. A font (or multiple fonts, in some arrangements) can be selected 910 based upon one or more selection rules, conditions, criteria, etc. For example, a predefined preference may be assigned to each decomposed component character (e.g., a high preference assigned to a base character) and a font may be selected based upon the character components assigned higher preferences. Once a font has been selected based upon the selection rules, conditions, criteria, etc., operations can be executed to set 912 the font currently being utilized to the selected font. Similar to processing based upon characters being assigned to different classes, computational efficiency may be improved by through decomposing character for font selection. For example, the amount of switching between fonts may be reduced based upon the analysis of decomposed characters.

Similar to using preferences to determine font selection, other types of rules, conditions, etc. may be utilized. For example, referring back to FIG. 5, due to the font switching (from a Devanagari font to a Latin font) to support the rendering of the character 506 (the letter “A”), the closing bracket character 510 utilizes the new font while the opening bracket character 504 (located before the character 506 that causes the font switch) would be rendered in the original font (the Devanagari font). One or more rules may be implemented by the text layout engine 200, the font service manager 316, etc. to assure that the same font is used to render both enclosure characters 504 and 510 as presented in the improved text string 512. For example, upon detecting that a font switch should occur, operations can be executed to review previous characters until another character supported by both fonts is detected (e.g., a common character) or a potential line break is detected. Various techniques may be implemented for detecting such line breaks, for example, rules for determining potential line breaks may be employed as promulgated by the Unicode Consortium in “Unicode Line Breaking Algorithm”, Unicode Standard Annex (UAX) #14, which is also incorporated by reference in its entirety herein. Once a previous common character, line break, etc. is detected operations can be executed to use the newer font (i.e., the switched to font) to render the characters located between the point of switching fonts and the previous common character, line break etc. As illustrated in FIG. 5, upon detecting the font switch for character 506, reviewing operations can step back through the previous characters until the first character common to both fonts (i.e., the opening bracket character 504) is detected. Once identified, that character and any character between it and the font switch point (i.e., the character 506) would be identified to be rendered in the new font (e.g., the Latin font). In effect, by reviewing the previous characters, common characters such as pairs of enclosure characters can be efficiently identified for rendering in the same font so as not to be distracting to the end viewer.

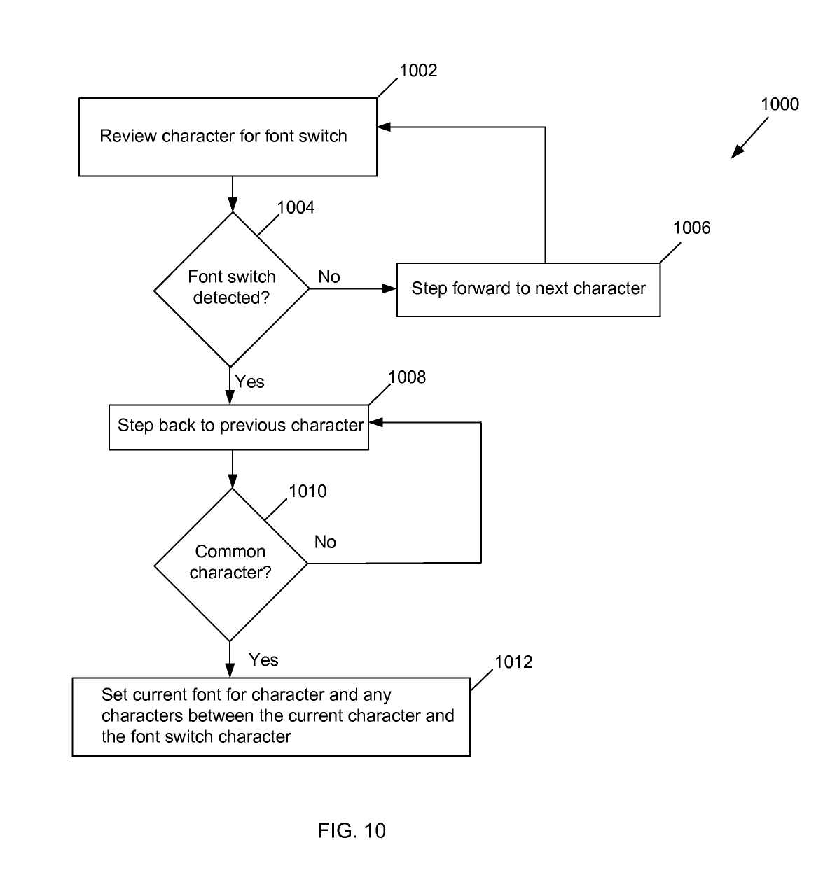

Referring to FIG. 10, a flowchart 1000 is presented that illustrates operations to look back once a font switch has been identified to determine if font assignments for prior characters should also be switched. Upon reviewing 1002 a character, operations can be executed to determine 1004 if a font switch has been detected (e.g., an instance of switching from a Devanagari font to a Latin font). If a switch has not been detected, the text layout engine 200, the font service manager 316, etc. steps to review 1006 the next character. If a font switch has been detected, operations are executed to determine if previous characters should have their font assignment adjusted (e.g., to assure the each pair of enclosure characters are rendered in the same font). After stepping back 1008 to a previous character, operations determine 1010 if the previous character is common to the two fonts (e.g., the character is supported by the font used before the font switch and the font used after the font switch). In some instances other conditions may be checked alone or in concert with checking for a common character. For example, characters representing line breaks, carriage returns, etc. may be investigated. For this particular arrangement, if a common character is not identified, operations are executed to step back to the next character. If a common character has been identified, the current font (i.e., the newly switched to font) is assigned to render that character. Additionally, the current font is also assigned to characters located between the detected common character and the later appearing character for which the font was originally switched. As such, operations include setting 1012 the current font for rendering the identified common character and any characters that appear between the detected common character and the character for which the character was originally switched.

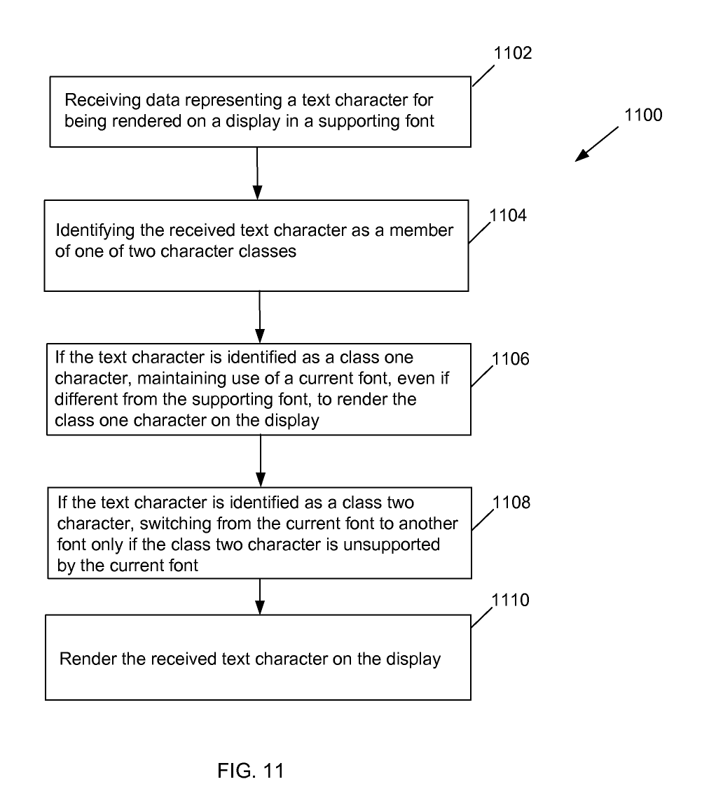

Referring to FIG. 11, a flowchart 1100 represents operations of a text layout engine (e.g., the text layout engine 200 shown in FIG. 2) being executed by a computing device (e.g., the smartphone 100, the server 314, etc.). Operations of the text layout engine are typically executed by a single computing device (e.g., the smartphone 100); however, operations may be executed by multiple computing devices. Along with being executed at a single site (e.g., the location of an end user), the execution of operations may be distributed among two or more locations. In some arrangements, a portion of the operations may be executed at the font service provider 302 (e.g., by the font service manager 316).

Operations of the text layout engine may include receiving 1202 data representing a text character for being rendered on a display in a supporting font. Operations may also include identifying 1104 the received text character as a member of one of two character classes. If the text character is identified as a class one character, operations may include maintaining 1106 use of a current font, even if different from the supporting font, to render the class one character on the display. If the text character is identified as a class two character, operations may include switching 1108 from the current font to another font only if the class two character is unsupported by the current font. Operations may also include rendering 1110 the received text character on the display.

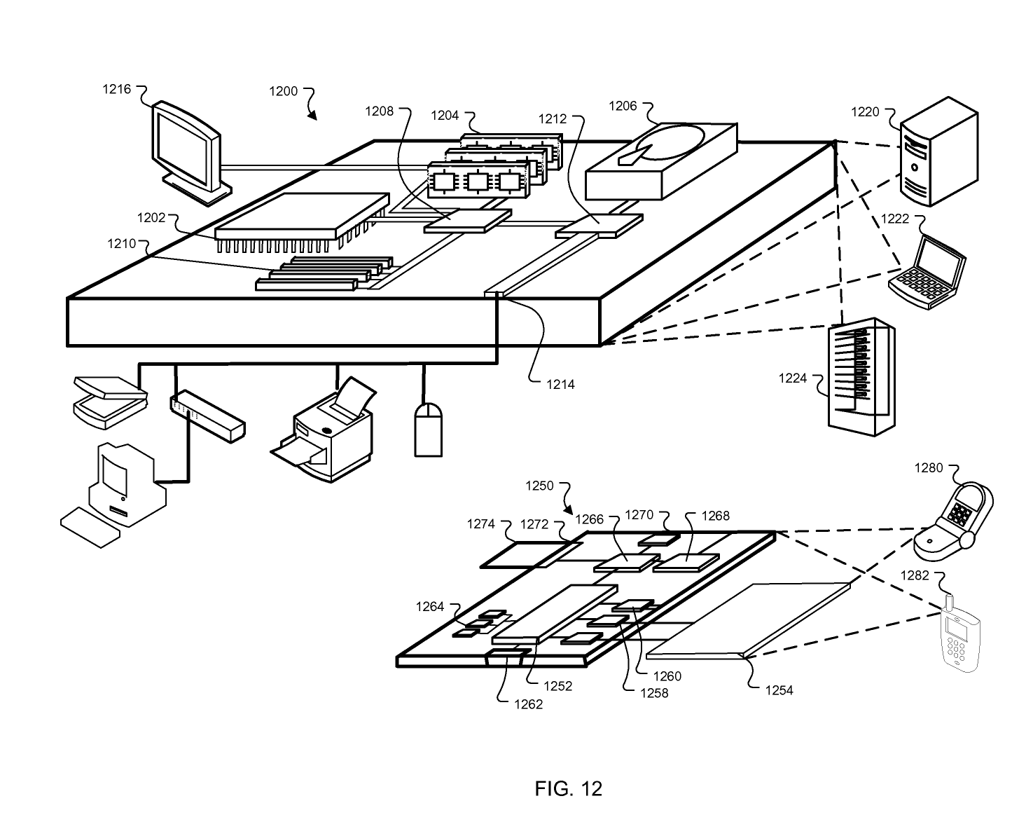

FIG. 12 shows an example of example computing device 1200 and example mobile computing device 1250, which can be used to implement the techniques described herein. For example, a portion or all of the operations of text layout engine 200 (shown in FIG. 2) may be executed by the computing device 1200 and/or the mobile computing device 1250. Computing device 1200 is intended to represent various forms of digital computers, including, e.g., laptops, desktops, workstations, personal digital assistants, servers, blade servers, mainframes, and other appropriate computers. Computing device 1250 is intended to represent various forms of mobile devices, including, e.g., personal digital assistants, tablet computing devices, cellular telephones, smartphones, and other similar computing devices. The components shown here, their connections and relationships, and their functions, are meant to be examples only, and are not meant to limit implementations of the techniques described and/or claimed in this document.

Computing device 1200 includes processor 1202, memory 1204, storage device 1206, high-speed interface 1208 connecting to memory 1204 and high-speed expansion ports 1210, and low speed interface 1212 connecting to low speed bus 1214 and storage device 1206. Each of components 1202, 1204, 1206, 1208, 1210, and 1212, are interconnected using various busses, and can be mounted on a common motherboard or in other manners as appropriate. Processor 1202 can process instructions for execution within computing device 1200, including instructions stored in memory 1204 or on storage device 1206 to display graphical data for a GUI on an external input/output device, including, e.g., display 1216 coupled to high speed interface 1208. In other implementations, multiple processors and/or multiple busses can be used, as appropriate, along with multiple memories and types of memory. Also, multiple computing devices 1200 can be connected, with each device providing portions of the necessary operations (e.g., as a server bank, a group of blade servers, or a multi-processor system).

Memory 1204 stores data within computing device 1200. In one implementation, memory 1204 is a volatile memory unit or units. In another implementation, memory 1204 is a non-volatile memory unit or units. Memory 1204 also can be another form of computer-readable medium (e.g., a magnetic or optical disk. Memory 1204 may be non-transitory.)

Storage device 1206 is capable of providing mass storage for computing device 1200. In one implementation, storage device 1206 can be or contain a computer-readable medium (e.g., a floppy disk device, a hard disk device, an optical disk device, or a tape device, a flash memory or other similar solid state memory device, or an array of devices, such as devices in a storage area network or other configurations.) A computer program product can be tangibly embodied in a data carrier. The computer program product also can contain instructions that, when executed, perform one or more methods (e.g., those described above.) The data carrier is a computer—or machine—readable medium, (e.g., memory 1204, storage device 1206, memory on processor 1302, and the like.)

High-speed controller 1208 manages bandwidth-intensive operations for computing device 1300, while low speed controller 1212 manages lower bandwidth-intensive operations. Such allocation of functions is an example only. In one implementation, high-speed controller 1308 is coupled to memory 1204, display 1216 (e.g., through a graphics processor or accelerator), and to high-speed expansion ports 1210, which can accept various expansion cards (not shown). In the implementation, low-speed controller 1212 is coupled to storage device 1206 and low-speed expansion port 1214. The low-speed expansion port, which can include various communication ports (e.g., USB, Bluetooth®, Ethernet, wireless Ethernet), can be coupled to one or more input/output devices, (e.g., a keyboard, a pointing device, a scanner, or a networking device including a switch or router, e.g., through a network adapter.)

Computing device 1200 can be implemented in a number of different forms, as shown in the figure. For example, it can be implemented as standard server 1220, or multiple times in a group of such servers. It also can be implemented as part of rack server system 1224. In addition or as an alternative, it can be implemented in a personal computer (e.g., laptop computer 1222.) In some examples, components from computing device 1200 can be combined with other components in a mobile device (not shown), e.g., device 1250. Each of such devices can contain one or more of computing device 1200, 1250, and an entire system can be made up of multiple computing devices 1200, 1250 communicating with each other.

Computing device 1250 includes processor 1252, memory 1264, an input/output device (e.g., display 1254, communication interface 1266, and transceiver 1268) among other components. Device 1250 also can be provided with a storage device, (e.g., a microdrive or other device) to provide additional storage. Each of components 1250, 1252, 1264, 1254, 1266, and 1268, are interconnected using various buses, and several of the components can be mounted on a common motherboard or in other manners as appropriate.

Processor 1252 can execute instructions within computing device 1250, including instructions stored in memory 1264. The processor can be implemented as a chipset of chips that include separate and multiple analog and digital processors. The processor can provide, for example, for coordination of the other components of device 1250, e.g., control of user interfaces, applications run by device 1250, and wireless communication by device 1250.

Processor 1252 can communicate with a user through control interface 1258 and display interface 1256 coupled to display 1254. Display 1254 can be, for example, a TFT LCD (Thin-Film-Transistor Liquid Crystal Display) or an OLED (Organic Light Emitting Diode) display, or other appropriate display technology. Display interface 1256 can comprise appropriate circuitry for driving display 1254 to present graphical and other data to a user. Control interface 1258 can receive commands from a user and convert them for submission to processor 1252. In addition, external interface 1262 can communicate with processor 1242, so as to enable near area communication of device 1250 with other devices. External interface 1262 can provide, for example, for wired communication in some implementations, or for wireless communication in other implementations, and multiple interfaces also can be used.

Memory 1264 stores data within computing device 1250. Memory 1264 can be implemented as one or more of a computer-readable medium or media, a volatile memory unit or units, or a non-volatile memory unit or units. Expansion memory 1274 also can be provided and connected to device 1250 through expansion interface 1272, which can include, for example, a SIMM (Single In Line Memory Module) card interface. Such expansion memory 1274 can provide extra storage space for device 1250, or also can store applications or other data for device 1250. Specifically, expansion memory 1274 can include instructions to carry out or supplement the processes described above, and can include secure data also. Thus, for example, expansion memory 1274 can be provided as a security module for device 1250, and can be programmed with instructions that permit secure use of device 1250. In addition, secure applications can be provided through the SIMM cards, along with additional data, (e.g., placing identifying data on the SIMM card in a non-hackable manner.)

The memory can include, for example, flash memory and/or NVRAM memory, as discussed below. In one implementation, a computer program product is tangibly embodied in a data carrier. The computer program product contains instructions that, when executed, perform one or more methods, e.g., those described above. The data carrier is a computer- or machine-readable medium (e.g., memory 1264, expansion memory 1274, and/or memory on processor 1252), which can be received, for example, over transceiver 1268 or external interface 1262.

Device 1250 can communicate wirelessly through communication interface 1266, which can include digital signal processing circuitry where necessary. Communication interface 1266 can provide for communications under various modes or protocols (e.g., GSM voice calls, SMS, EMS, or MMS messaging, CDMA, TDMA, PDC, WCDMA, CDMA2000, or GPRS, among others.) Such communication can occur, for example, through radio-frequency transceiver 1268. In addition, short-range communication can occur, e.g., using a Bluetooth®, WiFi, or other such transceiver (not shown). In addition, GPS (Global Positioning System) receiver module 1270 can provide additional navigation- and location-related wireless data to device 1250, which can be used as appropriate by applications running on device 1250. Sensors and modules such as cameras, microphones, compasses, accelerators (for orientation sensing), etc. may be included in the device.

Device 1250 also can communicate audibly using audio codec 1360, which can receive spoken data from a user and convert it to usable digital data. Audio codec 1360 can likewise generate audible sound for a user, (e.g., through a speaker in a handset of device 1350.) Such sound can include sound from voice telephone calls, can include recorded sound (e.g., voice messages, music files, and the like) and also can include sound generated by applications operating on device 1250.

Computing device 1250 can be implemented in a number of different forms, as shown in the figure. For example, it can be implemented as cellular telephone 1280. It also can be implemented as part of smartphone 1282, a personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor. The programmable processor can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a device for displaying data to the user (e.g., a CRT (cathode ray tube) or LCD (liquid crystal display) monitor), and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a backend component (e.g., as a data server), or that includes a middleware component (e.g., an application server), or that includes a frontend component (e.g., a client computer having a user interface or a Web browser through which a user can interact with an implementation of the systems and techniques described here), or a combination of such back end, middleware, or frontend components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. A computing device implemented method comprising:
receiving data representing a text character for being rendered on a display in a supporting font;
identifying the received text character as a member of one of two character classes;
if the text character is identified as a class one character, maintaining use of a current font, even if different from the supporting font, to render the class one character on the display; and
if the text character is identified as a class two character, switching from the current font to another font only if the class two character is unsupported by the current font; and
rendering the received text character on the display.

2. The computing device implemented method of claim 1, wherein the class one characters include non-viewable characters.

3. The computing device implemented method of claim 1, wherein the class two characters include characters displayable in multiple fonts.

4. The computing device implemented method of claim 1, wherein the class two characters include a viewable character that combines with another character to form a single character.

5. The computing device implemented method of claim 1, further comprising:
decomposing the received text character into component characters.

6. The computing device implemented method of claim 5, further comprising:
identifying a base component character for identifying a font for rendering other component characters.

7. The computing device implemented method of claim 6, wherein the base component character is identified from use of visual baseline space.

8. The computing device implemented method of claim 6, wherein identifying the font for rendering the other component characters is based upon the number of component characters representable by the font.

9. The computing device implemented method of claim 1, wherein identifying the received text character as a member of one of two character classes includes identifying a previously received text character that represents a common character or a line break.

10. The computing device implemented method of claim 1, wherein identifying the received text character as a member of one of two character classes is executed by a user computing device.

11. The computing device implemented method of claim 1, wherein identifying the received text character as a member of one of two character classes is executed at a font service provider.

12. A system comprising:
a computing device comprising:
a memory configured to store instructions; and
a processor to execute the instructions to perform operations comprising:
receiving data representing a text character for being rendered on a display in a supporting font;
identifying the received text character as a member of one of two character classes;
if the text character is identified as a class one character, maintaining use of a current font, even if different from the supporting font, to render the class one character on the display;
if the text character is identified as a class two character, switching from the current font to another font only if the class two character is unsupported by the current font; and
rendering the received text character on the display.

13. The system of claim 12, wherein the class one characters include non-viewable characters.

14. The system of claim 12, wherein the class two characters include characters displayable in multiple fonts.

15. The system of claim 12, wherein the class two characters include a viewable character that combines with another character to form a single character.

16. The system of claim 12, wherein executing the instructions perform operations comprising:
decomposing the received text character into component characters.

17. The system of claim 16, wherein executing the instructions perform operations comprising:
identifying a base component character for identifying a font for rendering other component characters.

18. The system of claim 17, wherein the base component character is identified from use of visual baseline space.

19. The system of claim 17, wherein identifying the font for rendering the other component characters is based upon the number of component characters representable by the font.

20. The system of claim 12, wherein identifying the received text character as a member of one of two character classes includes identifying a previously received text character that represents a common character or a line break.

21. The system of claim 12, wherein identifying the received text character as a member of one of two character classes is executed by a user computing device.

22. The system of claim 12, wherein identifying the received text character as a member of one of two character classes is executed at a font service provider.

23. One or more computer readable media storing instructions that are executable by a processing device, and upon such execution cause the processing device to perform operations comprising:
receiving data representing a text character for being rendered on a display in a supporting font;
identifying the received text character as a member of one of two character classes;
if the text character is identified as a class one character, maintaining use of a current font, even if different from the supporting font, to render the class one character on the display; and
if the text character is identified as a class two character, switching from the current font to another font only if the class two character is unsupported by the current font; and
rendering the received text character on the display.

24. The one or more computer readable media of claim 23, wherein the class one characters include non-viewable characters.

25. The one or more computer readable media of claim 23, wherein the class two characters include characters displayable in multiple fonts.

26. The one or more computer readable media of claim 23, wherein the class two characters include a viewable character that combines with another character to form a single character.

27. The one or more computer readable media of claim 23, further upon such execution cause the processing device to perform operations comprising:
decomposing the received text character into component characters.

28. The one or more computer readable media of claim 27, further upon such execution cause the processing device to perform operations comprising:
identifying a base component character for identifying a font for rendering other component characters.

29. The one or more computer readable media of claim 28, wherein the base component character is identified from use of visual baseline space.

30. The one or more computer readable media of claim 28, wherein identifying the font for rendering the other component characters is based upon the number of component characters representable by the font.

31. The one or more computer readable media of claim 23, wherein identifying the received text character as a member of one of two character classes includes identifying a previously received text character that represents a common character or a line break.

32. The one or more computer readable media of claim 23, wherein identifying the received text character as a member of one of two character classes is executed by a user computing device.

33. The one or more computer readable media of claim 23, wherein identifying the received text character as a member of one of two character classes is executed at a font service provider.
